(19) United States
(12) Patent Application Publication
(10) Pub. No.: US 2010/0211753 A1
(43) Pub. Date: Aug. 19, 2010

(54) Parallel garbage collection and serialization without per-object synchronization

(75) Inventor: Tatu J. Ylonen, Espoo (FI)

Correspondence Address: TATU YLONEN OY, LTD., KUTOJANTIE 3, ESPOO, 02630, FI

(73) Assignee: TATU YLONEN OY LTD, Espoo (FI)

(21) Appl. No.: 12/388,543

(22) Filed: Feb. 19, 2009

(51) Int. Cl. G06F 12/02; G06F 12/00; G06F 12/16; G06F 9/46

(52) U.S. Cl. 711/165; 718/102; 711/173; 711/170; 711/E12.002; 711/E12.001

(57) ABSTRACT

Parallel garbage collection, tracing, copying, and/or serialization of source memory areas is achieved without per-object synchronization instructions by dividing a source memory area into non-overlapping partitions, accessing each partition by only one thread at a time, and using a combination of global and thread-local data structures to minimize synchronization overhead and maximize achievable parallelism, while providing a full solution for handling pointers that cross partition boundaries.

### CROSS-REFERENCE TO RELATED APPLICATIONS

Not Applicable

### INCORPORATION-BY-REFERENCE OF MATERIAL SUBMITTED ON ATTACHED MEDIA

Not Applicable

### TECHNICAL FIELD

The present invention relates to memory management in computer systems, particularly garbage collection in multiprocessor systems. It is also relevant for serialization of large data structures.

### BACKGROUND OF THE INVENTION

An extensive survey of garbage collection is provided by the book R. Jones and R. Lins: Garbage Collection: Algorithms for Dynamic Memory Management, Wiley, 1996. This book is basic reading in the art of garbage collection.

An example of a modern garbage collector can be found in Detlefs et al: Garbage-First Garbage Collection, ISMM'04, pp. 37-48, ACM, 2004, which is hereby incorporated herein by reference.

Some garbage collectors utilize multiple threads for tracing and/or copying live objects in a memory area. Several techniques have been developed for synchronizing threads in such systems. Detlefs et al (2004) describes the use of atomic compare-and-swap instructions for installing forwarding pointers. C. Flood et al: Parallel Garbage Collection for Shared Memory Multiprocessors, USENIX Java Virtual Machine Research and Technology Symposium (JVM'01), Monterey, Calif., April 2001 describes a compacting mark-and-sweep garbage collector that uses partitioning for parallelizing various collection operations and implements a mark phase without synchronization operations. U.S. Pat. No. 7,191,300 describes a technique involving dividing a memory space into a plurality of non-overlapping sections and making pairs of source and target sections exclusively available to a process. U.S. Pat. No. 6,526,422 describes a system for performing card scanning in parallel by partitioning cards into subsets, each of which is associated with a thread. Y. Ossia et al: A Parallel, Incremental and Concurrent GC for Servers, PLDI'02, ACM, 2002, pp. 129-140 describe the use of work packets for load balancing. U.S. Pat. No. 6,823,351 describes the use of work-stealing queues for parallel garbage collection.

A problem with both locks and atomic compare-and-swap operations (which are used to build lock-free queues) is that they act as memory barriers and obtain exclusive use of a cache line, and are very expensive instructions in multiprocessor computers. Installing every forwarding pointer using an atomic instruction may be prohibitively expensive.

The method of dividing memory to non-overlapping sections mentioned above seems to assume a one-to-one mapping between source sections and target sections, and no solution is presented for handling references between sections.

### BRIEF SUMMARY OF THE INVENTION

The objective of the present invention is to provide a practical method for using multiple threads executing in parallel to trace and/or copy objects from a nursery or another region without using any locking or atomic instructions on a per-object basis (and without requiring dedicated bits in object headers as in Flood et al (2001)).

Since locking and atomic instructions are many (often hundreds) times more expensive than ordinary instructions on modern multiprocessor computers, this results in a very significant performance improvement for garbage collection. This is especially important for copying objects out of a young generation (nursery), but is also important for copying objects out of older generations or regions.

The memory area from which objects are traced/copied is called here the source memory area. Typically it would be the nursery (young object area) but can be also any other independently collectable region or generation or a set of regions/generations. Young objects are those objects created after the last garbage collection (particularly after the last time the nursery was garbage collected), whereas mature objects are any objects that have survived at least one garbage collection. An independently collectable memory area means a memory area that can be garbage collected without garbage collecting some or all other memory areas. For example, the nursery, each generation in a generational collector, and a region in the Garbage First collector could be considered independently collectable memory areas. Independently collectable memory areas generally require maintaining remembered sets or other records of pointers across area boundaries (card marking also being one way of maintaining such records).

The source memory area is divided (partitioned) into at least two partitions. The partitions may be of equal size, but this need not necessarily be the case. The number of partitions should preferably be at least a few times the number of threads performing garbage collection, in order to achieve automatic load balancing without the need to resort to work stealing or other special mechanisms. However, each partition should preferably be large enough to store at least tens or hundreds of objects so that any per-partition overhead is amortized among sufficiently many objects. In many systems, 64 or 128 is probably a good number of partitions (there is no requirement for the number or the partition size to be a power of two, but some computations can be performed more efficiently if the partition size is a power of two, which would typically imply that the number of partitions should preferably be a power of two as well).

At the heart of the invention is a way of organizing data structures and processing such that no synchronization is needed on the object level. Since there will be multiple partitions in at least some independently collectable memory areas according to the present invention, a partition may comprise pointers to objects in another partition, the objects being such that they are not reachable from the original entry points located in the partition where they reside. Thus, new entry points are discovered as partitions are analyzed.

The processing of the different partitions proceeds essentially asynchronously. It is possible that the processing of a partition has already completed when a new pointer (new entry point) to that partition is discovered while analyzing another partition. For such cases, a mechanism is provided that causes such new entry points to be processed, without using any synchronization mechanisms except very briefly when the processing of a partition completes.

The main benefit of the method is speeding up garbage collection in large multi-core and multiprocessor computers, and better scalability of garbage collection performance as the number of processors and memory buses grows.

Besides just running the young generation collection faster, the method allows using larger young generations while still keeping evacuation pauses short enough to be unnoticeable. A larger young generation means that a larger percentage of objects in the young generation is no longer reachable (live) when an evacuation pause occurs. This indirect effect further increases the performance gains due to the method, potentially allowing the overall young generation garbage collection performance to grow faster than linearly in the number of processing cores in some cases when combined with dynamic sizing of the young generation.

In mobile devices the present invention allows multiple processing cores to efficiently work together to implement the garbage collection operations. It can be expected that increasingly many mobile devices will utilize multiple cores in the future, not so much to improve performance, but to reduce power consumption, as two cores running at half speed consume significantly less power than one faster core. The present invention is well suited for such mobile devices, allowing them to make better use of multiple cores for power consumption reduction, while still keeping garbage collection pauses short. It can be expected that languages with garbage collection, such as Java, C#, or Javascript, will be widely used on such devices in the future.

The present invention is applicable to both mark-and-sweep and copying garbage collectors (including generational, incremental and train collectors that divide the memory to multiple independently collectable regions). With mark-and-sweep collectors the present invention does not require mark bits to reside with objects to avoid synchronization (unlike Flood et al (2001)).

Many aspects of the present invention are also applicable to parallel serialization of large object graphs.

### BRIEF DESCRIPTION OF THE SEVERAL VIEWS OF THE DRAWING(S)

FIG. 1 illustrates a computer system according to an embodiment of the invention.

FIG. 2 illustrates the single-threaded control logic of analyzing (garbage collecting) a source memory area.

FIG. 3 illustrates the control logic of each thread of execution while it is processing a partition.

### DETAILED DESCRIPTION OF THE INVENTION

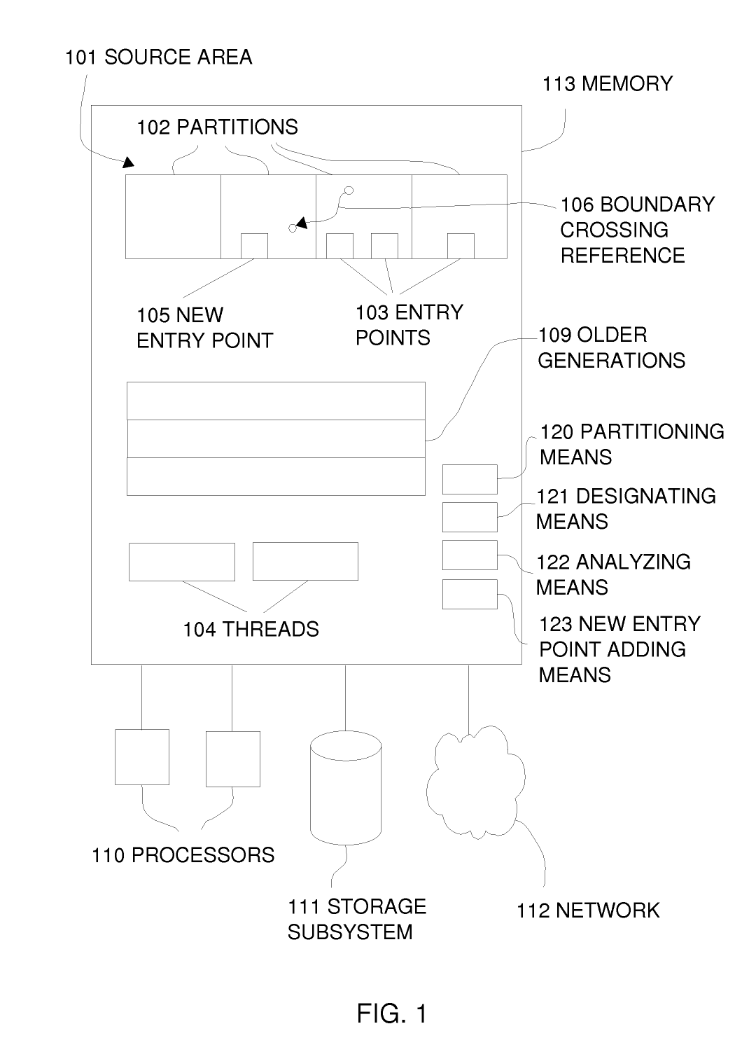

FIG. 1 illustrates a multi-core or multiprocessor (which are equivalent for the purposes of this disclosure) computer system according to an embodiment of the invention. (110) illustrates processors (or processing cores), (111) the storage subsystem (such as flash memory or magnetic disk), (112) a data communications network (such as the Internet or a wireless communications interface), and (113) the main memory of the computer system (typically a semiconductor memory, but other technologies may emerge in the future).

(101) illustrates a source memory area that the garbage collector is analyzing and from which it is optionally copying (moving, compacting) objects to older generations (109). The garbage collector may be processing multiple such source memory areas, either sequentially or in parallel, or interleaved (in which case one possibility would be to partition several source memory areas, and put all of their partitions in a single queue processed by a shared thread pool). For simplicity, the invention is described in the context of analyzing a single source memory area, but the intention is to cover also cases where multiple source memory areas are processed in parallel or in an interleaved fashion.

(102) illustrates non-overlapping partitions into which the source memory area (101) has been partitioned. Non-overlapping preferably means that the address ranges of the partitions do not overlap; however, an alternate embodiment of the invention would be to allocate partitions such that they overlap, but process them in such a way that an object in any memory location is only being processed (worked on) by one thread at a time (thus, the non-overlapping could be in temporal rather than spatial). The essence here is that objects in each partition can in general be processed without synchronization with processing in other partitions, and multiple threads can be processing (different partitions of) a single independently collectable region simultaneously.

(103) illustrates entry points to the partitions. Generally garbage collectors maintain remembered sets, card tables, or other mechanisms from which it can be determined which objects in any independently collectable region are reachable from the outside. It is the intention here that a source memory area is an independently collectable region (or a collection thereof), and at least some of the boundaries of partitions (102) are such that references across that partition (from objects in one partition in the source memory area to objects in another partition in the source memory area) are not tracked. Effectively, a partition comprises a proper subset of the memory addresses in an independently collectable memory area.

In the preferred embodiment, (102) is the nursery (young object area or young generation) and it is divided into approximately 16 to 256 partitions (a few times the number of physical processing cores or concurrently executing threads), and references to the nursery from old generation objects and roots can be determined by the garbage collector, but references across partition boundaries can only be determined by traversing the object graph in the nursery. (103) would then be those objects that are referenced from outside the nursery.

The independently collectable memory areas, such as the nursery, comprise objects (for example, structures, class instances, boxed cells, list nodes, arrays, strings). The objects frequently comprise pointers to other objects; the object comprising the pointer is then said to reference the object at the address indicated by the pointer. The object comprising the pointer is said to be the referencing object, and the object at the address indicated by the pointer is called the referenced object. In some embodiments pointers may also e.g. comprise tag bits, be indirect through an indirection pointer, or may be indexes to an array that can be used to obtain the real pointers. In some embodiments some pointers may also be special identifiers that are mapped to real objects using a suitable index data structure, such as a hash table, or proxy objects referring to objects in other computing nodes of a distributed system.

(104) represent threads that are used to process the partitions during garbage collection. A thread of execution is an abstraction in concurrent programming that roughly corresponds to a logical processor. A thread has its own stack and own registers; typically threads are multiplexed among physical processors by the operating system. In the preferred embodiment of the present invention, there are (approximately) as many threads processing the partitions as there are physical processors. It should be noted, however, that in some embodiments much of the garbage collector could be implemented directly in hardware (e.g. semiconductor logic in an ASIC), in which case the threads of execution might correspond to state machines (possibly with stacks) or dedicated processors. In such an embodiment, the partitions might be fixed at system design time, and even reside in separate physical memory units with dedicated access path(s) from a thread (state machine) to partitions preferably processed by it. The various lists or queues could be implemented as FIFOs or special memories.

While the partitioning is described as a step herein and in the claims, it could also be computed once when the program starts, recomputed whenever the size of the nursery changes, or determined at compilation, system configuration or design time (e.g. when critical system parameters such as memory size are set for mobile devices). Thus, in some embodiments the step of partitioning the source memory area can be implemented by accessing an already existing partitioning. It is, however, essential for the present invention that there be at least two non-overlapping partitions.

Since references across partition boundaries (106) are generally only discovered while analyzing the object graph reachable from existing entry points, such entry points cannot in general be added before processing the partitions by parallel threads begins. An important aspect of the present invention is adding such new entry points (105) discovered during analysis into the partitions, and causing them to be analyzed even if analysis of the partition has otherwise already terminated. Such new entry points can be added as soon as they are discovered (especially if the partition where they are to be added did not previously have unprocessed entry points), or they may be collected in a thread-local data structure maintained by each thread, and then moved from thread-local storage to the relevant partition's data structures when processing of existing entry points in the referring partition is complete.

The preferable time to add new entry points to the referenced partition is affected by the concurrency control overhead related to such additions. Multiple threads might want to add new entry points to the same partition simultaneously, and some form of concurrency control (such as locks or use of lock-free data structures) is needed. Since a synchronizing operation can cost the equivalent of approximately a thousand normal instructions in a multiprocessor system (even when it doesn't block), it is generally desirable to group several additions in thread-local storage before moving them to the referenced partition. In the preferred embodiment, the new entry points are moved to the referenced partition's data structures immediately if the referenced partition was not previously being processed by a thread or queued for processing. This causes parallelism to spread maximally fast when initially there is only one or a few entry points to the nursery. Otherwise the new entry points are queued in thread-local storage and moved when processing of the referencing partition completes.

The computer system also comprises various components specific to the methods of the present invention. These components are preferably implemented by executable program code stored in the main memory of the computer that causes the computer to perform the activities described herein, but in a hardware implementation they could at least partially be implemented in semiconductor logic (or equivalent).

The present invention is primarily targeted for use in computer systems that perform garbage collection and/or serialization by a garbage collection or serialization means comprising a partitioning means (120), a designating means (121), an analyzing means (122), and a new entry point adding means (123); however, there may also be other applications and embodiments.

(120) illustrates the partitioning means that partitions the source memory area into non-overlapping partitions. In the preferred embodiment the partitioning for the nursery is performed once when the program starts (or when the first garbage collection is performed). In embodiments where the size of the nursery can change, it would preferably be performed whenever the nursery size changes. Another partitioning could be computed for other independently collectable regions, assuming they are of identical sizes (if not, then the partitioning would preferably be computed when needed).

The partitioning implemented by the partitioning means influences the practically achieved parallelism in situations where the number of entry points to the nursery is initially small and concentrated in the most recently written part of the nursery. This is expected to be common.

One approach to speeding up discovery of entry points in other partitions is to use uneven partition sizes, with the most recently allocated part of the nursery divided into smaller partitions than the older part of the nursery (as the youngest part likely has more entry points from registers and stacks, and probably has a higher density of live objects). Another approach is using TLABs (thread-local allocation buffers) in mutators that are smaller than partitions in the garbage collector, and allocating them such that each of the most recently allocated TLABs ends up in a different partition (e.g. by pre-dividing the nursery into TLABs, and permuting them such that the N last TLABs each reside in a different partition). A further approach is to queue partitions for processing by threads in such an order that the partitions comprising the youngest objects will be processed first (a possible alternative strategy would be to prioritize processing of the partitions by the number of entry points to them, e.g. using a priority queue). One or more of these strategies as well as the strategy of adding new entry points in their respective partitions before processing of the partition containing the reference has completed may be implemented as a means for maximizing the spread of parallelism. While the means for maximizing the spread of parallelism is preferably implemented in software, it may also be hard coded in e.g. ASIC implementations for mobile devices.

(121) illustrates the designating means that determines which objects are entry points, i.e., reachable from other independently collectable memory areas, registers, application thread stacks, and other root pointers. For each entry point, it is determined which partition it belongs to, and it is added to that partition's data structure. (The extraction of the roots may be done either before or after partitioning, or even concurrently with it. It is even conceivable to start processing partitions as soon as their first entry point has been added, before some other roots have been extracted.)

(122) illustrates the analyzing means that analyzes a partition. The analyzing means is executed by a thread that has exclusive access to the partition while it is analyzing it. The analyzing process generally involves traversing the object graph in that partition. Any known method of traversing an object graph can be used, including but not limited to recursive, iterative, and work list based variants. Since the size of a partition is fairly limited, it may be possible to use more efficient traversal mechanisms than a general traversal, since the size of the partition sets a maximum limit on the size of any stack needed. However, the traversal used here differs from standard traversal mechanisms in that only the subgraph in the current partition is traversed; if a pointer to another partition is encountered, then traversal of that branch of the graph stops at the boundary crossing (and the object behind the boundary crossing reference is made a new entry point in its respective partition).

During the traversal, a bitmap, array, mark bits, forwarding pointers, hash table, or other suitable mechanism is used to detect when an object that has already been visited is encountered again. It is important to detect such objects, as otherwise the traversal would take much longer than needed (possibly exponentially longer) or get stuck in infinite loops. It is well known in the art how to detect such objects with multiple references and how to prevent processing them more than once.

The traversal basically determines which objects in the partition are reachable from each entry point (or at least some entry point). In some embodiments the traversal may be only partial, such as when a serialization process would ignore certain fields in certain data types that have been specified as not to be included in a serialized representation (such fields would typically contain e.g. internal implementation data that is recomputed every time the data is loaded into memory).

While analyzing a partition, each pointer is checked to see whether it points out from the current partition. This test can be implemented using code such as the following:

```
if ((UInt64)pointer − partition_start >= partition_size)
  if (pointer points to the source memory area)
    ... boundary crossing reference (record it);
  else
    ... pointer points out from the source area;
```

Pointers out from the source memory area may or may not require special handling depending on the embodiment. When the source region is the nursery, the pointer would typically be recorded as an entry point in the remembered sets associated with the old generation (or region) that it points to. Such recording is known in the art and beyond the scope of the present disclosure.

Pointers crossing boundaries are very important, and as already discussed above, they may be recorded either in thread-local data structures and later moved to the referenced partition, or immediately added to the referenced partition.

Thread-local data structure means a data structure private to the thread accessing it, so that the thread can safely access it without any synchronization with other threads. Each thread has its own thread-local data structures.

In the preferred embodiment, a special data structure (node) is used to record information about each entry point, and the node comprises a ‘next’ field that can be used as the pointer to the next node on a list (the entry point also identifies an object, typically by comprising a pointer to the object). The thread-local data structure comprises a list with a head pointer and a tail pointer for each partition (e.g., two arrays heads[ ] and tails[ ], or a single array combining the two fields in each element). For each boundary crossing reference a node is created and added to the list for the referenced partition in the thread-local data (at either head or tail; it does not matter here), and the head and tail pointers are updated accordingly. Managing singly linked lists with head and tail pointers is well known in the art. Other data structures, including doubly linked lists, double ended queues (deques), or lists without tail pointers, could also be used, but they have more overhead. An advantage of the present invention over the prior art is that all of its lists can be simply linked lists (with tail pointers), which consume less memory and are faster to manipulate than doubly linked lists or deques, and significantly faster than their lock-free variants (which require synchronization primitives, such as compare-and-swap, which are costly).

A possible optimization in the allocation of the nodes for entry points is to have a thread-local stash of them, and only allocate them from a global pool (several at a time) if the local stash is empty. Such allocation is known in the art.

The code to record a cross-boundary reference could look something like the following (here, ‘node’ is an already allocated entry point node, and ‘ctx’ refers to thread-local data):

node->next = ctx->heads[partition_number];
ctx->heads[partition_number] = node;
if (ctx->tails[partition_number] == NULL)
ctx->tails[partition_number] = node;

No locking or synchronization is needed here, since the list is in thread-local data. (The list could also use e.g. node indexes as an alternative to memory addresses as pointers.)

Marking, copying, or other operations may be performed by the analysis means on the traversed objects in this step in addition to just the traversal. It may also save information about some or all of the objects for use later in garbage collection. Such later steps could include e.g. updating “eq hash tables” (i.e., hash tables where the key is compared using pointer equality). Such “eq hash tables” could be recorded in a separate data structure (whether global or thread-local) listing all eq hash tables, as such hash tables generally require special processing as the keys of the hash table change when objects are moved (copied) in memory.

In some embodiments copying might be delayed until after a partition has been analyzed. A possibility for such embodiments is to mark any objects with more than one reference in a special bitmap and record any objects with more than one reference during traversal. The traversal process needs to detect cycles and shared data structures anyway, and the same data structure can be used to detect when an object has multiple references (it has multiple references if the data structure indicates it has already been visited when it is entered during traversal).

Objects with multiple references form roots of (possibly degenerate) trees of objects. Such trees can then be copied very simply and efficiently by using the special bitmap to check whether a pointer points to an object with more than one reference, without tracking which objects have already been visited at this stage. A system using such trees advantageously has been described in in U.S. Ser. No. 12/147,419 by the same inventor.

The copying could be done while analyzing the partition, after processing all partitions as a separate step (preferably using multiple threads executing concurrently to parallelize the copying), or gradually in between (for example, copying could start as soon as threads become available from analyzing regions). Such copying could then be performed without any concurrency control. Delaying copying until after the analysis phase may improve cache locality during analysis and thus improve performance.

One possibility for recording such objects with multiple references would be to add them to the same list that contains processed entry points. Since that list is only accessed by a thread currently processing the partition, the thread could add them to that list without any synchronization. Alternatively, it could have a separate list for such objects (or their representative nodes).

It should also be understood that copying in garbage collectors does not necessarily mean a bitwise exact copy. For example, pointer fields may sometimes be adjusted as other objects are moved, and in some embodiments the garbage collector may compact objects or pointers contained therein, such as when implementing the well known “cdr consing” technique in Lisp. In distributed garbage collectors the copying could sometimes mean an even more radical transformation or encoding of the object, including potentially sending it over a network to a different computer and replacing the original object by a proxy that points to the object in the different computer, or doing the reverse of replacing a proxy by the real object.

The new entry point adding means (123) is used at least when processing a partition has completed to move new entry points from the thread-local data structure to their respective partitions. In the preferred embodiment, each partition has a lock for the list(s) of that partition, and this lock is momentarily taken when adding new entry points to the partition.

In some embodiments the code for moving entry points to the respective partitions would look something like the following (here, ‘ctx’ refers to thread-local data, and the ‘partitions’ array represents global data about partitions):

```
for (i = 0; i < NUM_PARTITIONS; i++)
  if (ctx->heads[i] != NULL)
    {
      Boolean schedule = FALSE;
      Partition p = &partitions[i];
      mutex_lock(&p->mutex);
      if (p->pending_tail == NULL)
        {
          p->pending_head = ctx->heads[i];
          p->pending_tail = ctx->tails[i];
      }
      else
        {
          p->pending_tail->next = ctx->heads[i];
          p->pending_tail = ctx->tails[i];
        }
      if (p->done)
        {
          p->done = FALSE;
          schedule = TRUE;
        }
      mutex_unlock(&p->mutex);
      ctx->heads[i] = NULL;
      ctx->tails[i] = NULL;
      if (schedule)
        cause partitions[i] to be (re)processed;
    }
```

In the pseudocode above, ‘ctx->heads[ ]’ and ‘ctx->tails[ ]’ are arrays indexed by a partition number, containing the head and tail pointers for the thread-local singly linked list for each partition, the list containing new entry points found in other partitions while processing the current partition. The global data for each partition here comprises a singly linked list of unprocessed (new) entry points, with ‘pending_head’ and ‘pending_tail’ as its head and tail pointers.

Causing a partition to be reprocessed (i.e., scheduling its processing) would typically involve putting the partition into a queue of partitions waiting to be processed (the putting usually involving the use of a mutex or a lock-free list method), checking if the maximum number of threads is already running, and starting or waking up an additional thread to process partitions in the queue if appropriate. Alternatively, it could be scheduled as a task to perform for some kind of more general worker thread mechanism provided by the operating system or run-time libraries. (It is known in the art how to implement such work queues, thread pools and/or worker threads, and how to handle synchronization and termination in them properly.)

It would also be possible to have only a single list of cross-boundary references in thread-local data (containing references pointing to any partition), and determine which partition each reference points to when moving them to the partitions, and then adding each one to the appropriate partition. This might be preferable if a single lock was used to protect all per-partition lists. Overall, however, the preferred mode is to use one list for each partition.

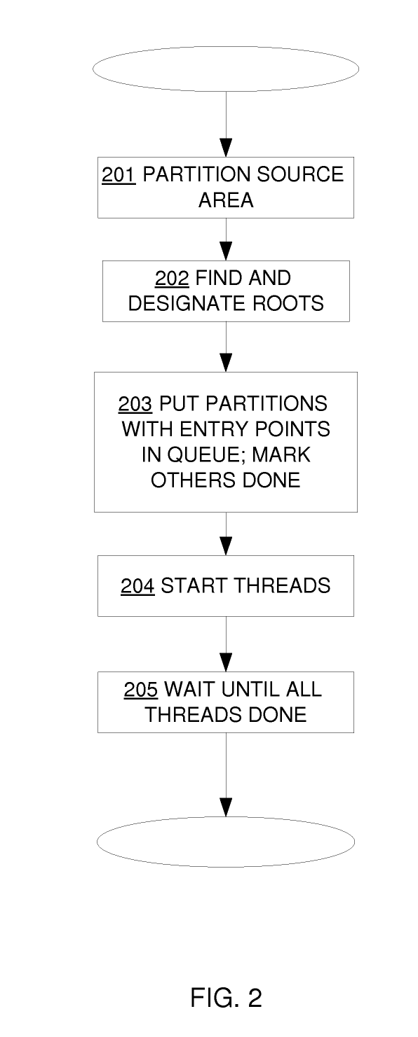

FIG. 2 illustrates the overall process of performing garbage collection according to the present invention, as was largely already described above. (201) illustrates partitioning the source memory area, (202) finding (discovering) the entry points to the source memory area and designating them as entry points in each partition (entry point nodes may be allocated for them if the remembered set data structures cannot directly serve as entry point nodes), and they are added to the respective partition's (pending) entry points list.

(203) illustrates putting the partitions into a work queue and causing more than one thread to process them in parallel as described above. In the preferred embodiment, only those partitions are added to the work list that have at least one entry point. Any partitions that do not have any entry points are marked as done (the partition data structure preferably has a ‘done’ field or equivalent, which when set indicates that the partition is not on the work list or currently being processed; this field is set when a thread has completed processing the partition, and it is cleared whenever the partition is put on the work queue).

(204) illustrates starting or waking up the threads in the thread pool that processes the work queue; when the thread pool is implemented by the operating system or a library, the thread pool is generally not directly visible to the application program, and the suitable number of threads is automatically started by the library or operating system, and this step may be combined with (203)).

(205) illustrates waiting until the threads have completed their work; it basically just means waiting until processing of all queued partitions has completed. A number of known ways are available for implementing the termination protocol, including the use of a count of scheduled objects, which is decremented whenever a partition has been processed, having the main thread wait on a condition variable in (205), and signalling that condition variable from the worker thread when the counter becomes zero (the counter would then typically be protected by a lock). The termination mechanism may also be implemented using callbacks, messages, pthread_join( ), and a number of other known solutions.

The steps in FIG. 2 can generally be performed in more or less any order, and even interleaved or be performed simultaneously (however, waiting for termination would naturally happen near the end of the sequence).

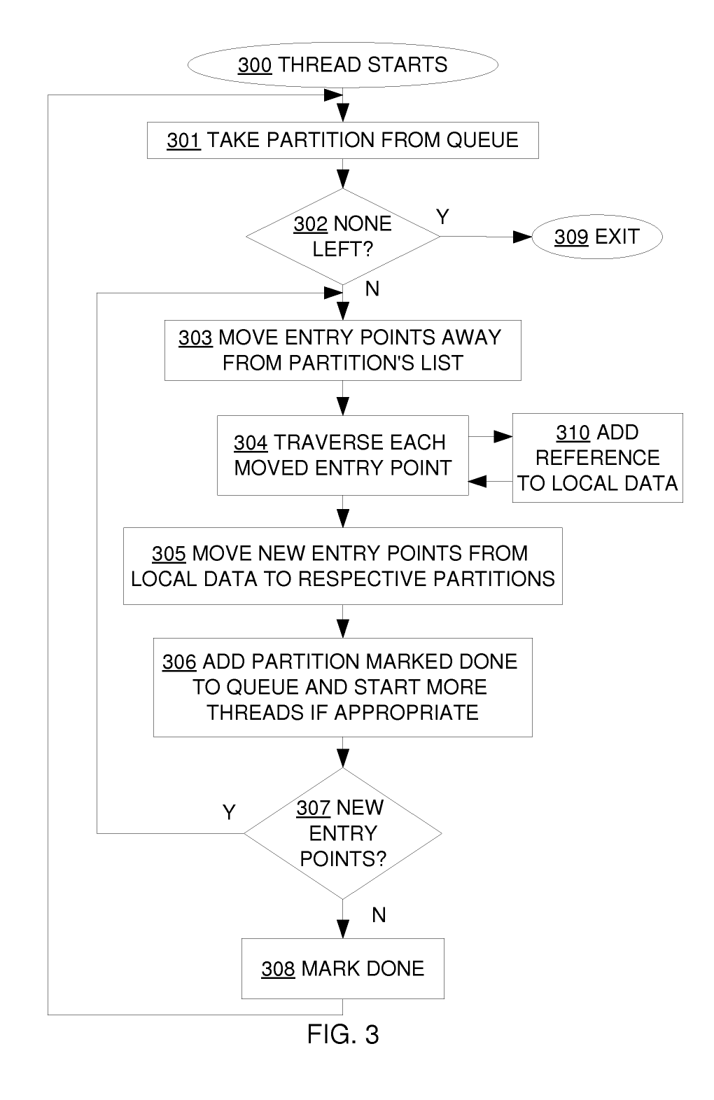

FIG. 3 illustrates the actions performed by a worker thread (whether implemented entirely in the application or partially in the operating system or library). (300) illustrates where a thread starts or wakes up, (301) takes a partition (work task) from the queue, (302) (typically combined as part of (301)) checks if there were any partitions (work tasks) remaining, and the thread exits or goes to sleep in (309) if there were none. These steps are known parts of implementing a work queue using a thread pool, and can be implemented using any known implementation for work queues. Some form of synchronization would generally be needed in the implementation of the work queue, especially steps (301) and (302). Applicable known synchronization methods include both locking and lock-free queues. A separate thread could also be created for processing each partition, thus mostly omitting steps (301) and (302).

(303) takes one or more entry points from the partition's list. This would generally need some form of locking. In the preferred embodiment, the implementation is something like:

```
mutex_lock(&p->mutex);
EntryPoint head = p->pending_head;
EntryPoint tail = p->pending_tail;
p->pending_head = NULL;
p->pending_tail = NULL;
if (p->processed_head == NULL)
  {
    p->processed_head = head;
    p->processed_tail = tail;
  }
else
  {
    p->processed_tail->next = head;
    p->processed_tail = tail;
  }
mutex_unlock(&p->mutex);
```

The code above takes the list of pending (new) entry points, appends them to a second singly linked list (with head and tail in ‘processed_head’ and ‘processed tail’), and leaves the list available for thread-local access in ‘head’ and ‘tail’. Note that if only partitions that have some entry points are put in the work queue, it is known above that the pending list is non-empty. Also, the lists could be joined in either order (i.e., either list could be appended to the other).

(304) illustrates traversing the object graph within the partition, as described above for the analyzing means (122). Any known traversal method may be used. Sometimes the traversal is likely to encounter a pointer that points to another partition in the same source memory area (i.e., a boundary-crossing reference). For such pointers, the code in (310) is performed to add information about the reference in thread-local data structures, as described earlier. Marking, copying, or other operations may be performed on the traversed objects in this step in addition to just the traversal. The step (304) is thus highly complex and may comprise a high degree of variability, but is largely beyond the scope of this disclosure. Many ways of implementing such traversal and related marking or copying operations are known in the art (see e.g. the book by Jones and Lins (1996) as a starting point).

(305) illustrates moving entry points from local data to the respective partitions, as already described above for the new entry point adding means (123). Sometimes the actions performed in (305) may be performed inside (304) or (305), for example to schedule processing of a partition immediately when the first entry point is found for it.

(306) illustrates causing a partition to which new entry points were added to be (re)processed if its processing had already been completed (or if it had not yet had entry points during the current garbage collection cycle/evacuation pause). The details of this were already described above. This step can generally be combined with (305).

(307) checks if the partition just processed has had new entry points added to its pending (new) entry points list while it was processing the entry points taken earlier from that list. If new entry points are available, execution returns to (303) to take those entry points from the list and process them. This step would use a lock to synchronize access to the pending list in the preferred embodiment.

Step (308) marks the partition as processed by setting its ‘done’ field to true. This would usually be done atomically with (307) while holding the lock.

Steps (307) and (308) could equally well be integrated with step (303), so that (303) locks the partition, checks if the pending list is empty, and if so, marks the partition as done, unlocks the partition and returns to (301).

While the invention has been described as being performed at garbage collection time (during an evacuation pause), some modern garbage collectors do not have a clear separation between garbage collection and mutator execution times. Real-time garbage collectors are designed to minimize any pause times to mutators, and some garbage collectors manage to perform nearly all garbage collection work while mutators are executing, and pause times can be measured in microseconds. The present invention is also applicable to such garbage collectors, and could run in parallel with mutators, with generally similar precautions for mutator interaction as are otherwise needed in a particular garbage collector. In such systems, it may be desirable to use fewer threads for garbage collection than there are physical processors in the computer, in order to leave more resources for mutator execution.

While the invention has mostly been described in the context of garbage collection and as a garbage collection method, it is also applicable to serializing very large data structures. Serialization of large data structures also requires determining which objects are reachable from (typically one) root object(s), and encoding such objects to a data stream that becomes the serialized representation. The main difference in the method when applied to serialization is that copying in this case is more a form of specialized encoding (similar to ones sometimes used in distributed garbage collection), and the objects are copied (encoded) to a buffer (typically string or I/O buffer) rather than to a mature object memory area. Almost all aspects of the present invention are directly applicable to parallel serialization of large data structures, and this disclosure is intended to cover also such embodiments. For additional details and references on serialization see U.S. Ser. No. 12/360,202 and U.S. Ser. No. 12/356,104 by the same inventor, which are hereby incorporated herein by reference.

One aspect of the present invention is a method for implementing garbage collection or serialization in a multiprocessor computer system, comprising:
partitioning a source memory area into at least two non-overlapping partitions
designating one or more objects in one or more of the partitions as entry points
using more than one thread executing in parallel to analyze the partitions, each partition being worked on by at most one thread at a time, the thread at least partially determining which objects in that partition are reachable from the entry points designated for the partition
adding at least one new entry point to at least one other partition after a thread completes analyzing a first partition, the new entry point identifying an object in the other partition referenced from the first partition; and
if analyzing a partition has already completed when a new entry point is added to it, causing a thread to analyze any new entry points added to the partition.

Another aspect of the invention is a multiprocessor computer system comprising a garbage collection or serialization means comprising:
a partitioning means (120)
a designating means (121)
an analyzing means (122)
a new entry point adding means (123)

wherein the analyzing means utilizes more than one thread executing in parallel, each partition is processed by at most one thread at a time, the analyzing means at least partially determines which objects in each partition are reachable from entry points designated for each partition by the designating means or entry points discovered by the analyzing means, and the new entry point adding means at least in some situations causes the analyzing means to process new entry points added to a partition even if processing of previously added entry points in that partition has already completed.

A further aspect of the invention is a computer program product, stored on a machine-readable medium, the computer program product being operable to perform garbage collection or serialization in a multiprocessor computer, causing the computer to:
comprise a partitioning means (120)
comprise a designating means (121)
comprise an analyzing means (122)
comprise a new entry point adding means (123)
analyze more than one partition in parallel using more than one thread executing in parallel, however each partition being analyzed by only one thread at any given time
determine which objects in each partition are reachable from entry points designated for the partition or from new entry points added to the partition
schedule the processing of a partition if a new entry point is added to it after the processing of previously added entry points in it has already completed
copy a plurality of objects.

In this specification, “multiple” means more than one.

Many variations of the above described embodiments will be available to one skilled in the art without deviating from the essence of the invention as set out herein and in the claims. In particular, some operations could be reordered, combined, or interleaved, or data structures could be somewhat different.

It is to be understood that the aspects and embodiments of the invention described herein may be used in any combination with each other. Several of the aspects and embodiments may be combined together to form a further embodiment of the invention. A method, a computer system, or a computer program product which is an aspect of the invention may comprise any number of the embodiments of the invention described herein.

What is claimed is:

1. A method for implementing garbage collection or serialization in a multiprocessor computer system, comprising:
partitioning a source memory area into at least two non-overlapping partitions
designating one or more objects in one or more of the partitions as entry points
using more than one thread executing in parallel to analyze the partitions, each partition being worked on by at most one thread at a time, the thread at least partially determining which objects in that partition are reachable from the entry points designated for the partition
adding at least one new entry point to at least one other partition after a thread completes analyzing a first partition, the new entry point identifying an object in the other partition referenced from the first partition; and
if analyzing a partition has already completed when a new entry point is added to it, causing a thread to analyze any new entry points added to the partition.

2. The method of claim 1, wherein the analysis step comprises traversing the object graphs rooted at the object identified by each entry point to the partition to the extent such object graphs are located within the partition.

3. The method of claim 1, wherein the source memory area comprises the nursery.

4. The method of claim 1, further comprising:
allocating TLABs in mutators in such a way that the most recently allocated TLABs end up in different partitions in the partitioning step.

5. The method of claim 1, wherein the partitioning is such that partitions comprising the youngest objects are smaller than partitions comprising the oldest objects.

6. The method of claim 1, wherein the partitions are processed by the threads starting from the partitions comprising the youngest objects.

7. The method of claim 1, wherein the data structure maintained for each partition comprises:
a lock
a head pointer and a tail pointer for a singly linked list containing any entry points for the partition that have not yet been taken for processing by a thread; and
wherein each entry point node comprises a ‘next’ field used as the forward pointer in the list, access to this list by the threads processing partitions is protected by the lock, and designating an object as an entry point for a partition means adding the entry point node on this list.

8. The method of claim 1, wherein analyzing a partition by a thread also comprises:
copying at least one object reached during traversal to a new memory location.

9. The method of claim 1, further comprising:
while analyzing a partition by a thread, determining which objects have more than one reference, and recording such objects in a data structure; and
copying trees of objects rooted by objects having more than one reference.

10. The method of claim 9, wherein the copying is performed as a separate step after all partitions have been analyzed and multiple objects are copied simultaneously using more than one thread to perform the copying.

11. The method of claim 9, wherein objects having more than one reference are added to the same list that contains processed entry points without any synchronization.

12. The method of claim 1, wherein a plurality of new entry points are added to a referenced partition in a single synchronized operation.

13. The method of claim 12, further comprising:
while a thread is analyzing a partition, collecting references to objects in other partitions in a data structure that is local to that thread
adding new entry points to one or more other partitions by moving all entry points collected in the local data structure that belong to the other partition in a single synchronized operation.

14. The method of claim 12, wherein adding the plurality of new entry points to a partition comprises:
taking a singly linked list with head and tail pointers for the partition from the thread-local data of the current thread
locking data structures for the partition
joining said list into the pending list for the partition
unlocking data structures for the partition.

15. The method of claim 1, wherein at least some new entry points are added to the respective partition as soon as the boundary crossing reference has been discovered, and the partition is queued for processing if the referenced partition did not previously have any entry points.

16. The method of claim 1, wherein causing new entry points in a partition to be processed comprises:
checking a ‘done’ field in the data structure for the partition
if the ‘done’ field indicates that the partition is currently not in the work queue, adding the partition to the work queue, and if less than the maximum number of threads are currently processing partitions from the queue, starting or waking up a thread for processing them.

17. A multiprocessor computer system comprising a garbage collection or serialization means comprising:
a partitioning means (120)
a designating means (121)
an analyzing means (122)
a new entry point adding means (123)
wherein the analyzing means utilizes more than one thread executing in parallel, each partition is processed by at most one thread at a time, the analyzing means at least partially determines which objects in each partition are reachable from entry points designated for each partition by the designating means or entry points discovered by the analyzing means, and the new entry point adding means at least in some situations causes the analyzing means to process new entry points added to a partition even if processing of previously added entry points in that partition has already completed.

18. The computer system of claim 17, further comprising a means for maximizing the spread of parallelism.

19. The computer system of claim 17, further comprising:
a means for recording discovered boundary crossing references in a thread-local data structure stored in memory device; and
a means for atomically adding more than one object pointed to by a recorded boundary crossing reference as new entry points in their respective regions.

20. The computer system of claim 17, further comprising:
a means for copying objects to a new memory location.

21. The computer system of claim 20, wherein the means for copying objects to a new memory location comprises:
a means for determining which objects have more than one reference; and
a means for copying trees of objects rooted at objects having more than one reference.

22. A computer program product, stored on a machine-readable medium, the computer program product being operable to perform garbage collection or serialization in a multiprocessor computer, causing the computer to:
comprise a partitioning means (120)
comprise a designating means (121)
comprise an analyzing means (122)
comprise a new entry point adding means (123)
analyze more than one partition in parallel using more than one thread executing in parallel, however each partition being analyzed by only one thread at any given time
determine which objects in each partition are reachable from entry points designated for the partition or from new entry points added to the partition
schedule the processing of a partition if a new entry point is added to it after the processing of previously added entry points in it has already completed; and
copy a plurality of objects.
